(19) United States
(12) Patent Application Publication
(10) Pub. No.: US 2023/0354738 A1
(43) Pub. Date: Nov. 9, 2023

(54) METHOD FOR ADAPTING A PROCESS MODEL FOR OPERATING ONE OF MULTIPLE WORKING MACHINES, IN PARTICULAR HARVESTING MACHINE FOR ROOT CROPS

(71) Applicant: Grimme Landmaschinenfabrik GmbH & Co. KG, Damme (DE)

(72) Inventors: Daniel Bösenberg, Emsdetten (DE); Wolfram Strothmann, Osnabrück (DE)

(21) Appl. No.: 18/004,476

(22) PCT Filed: Jul. 1, 2021
(86) PCT No.: PCT/EP2021/068234

§ 371 Date: Jan. 7, 2023

(30) Foreign Application Priority Data
Jul. 7, 2020 (DE) 10 2020 117 941.3

(51) Int. Cl. A01D 33/00; A01D 41/127; A01B 79/00

(52) U.S. Cl. CPC A01D 33/00; A01D 41/127; A01B 79/005

(57) ABSTRACT

A method is provided by which a particularly good agricultural work result is achieved upon use both at the same location and also at other locations for one or multiple agricultural working machines.

### CROSS REFERENCE

This application claims priority to PCT Application No. PCT/EP2021/068234, filed Jul. 1, 2021, which itself claims priority to German Patent Application No. 10 2020 117941.3, filed Jul. 7, 2020, the entireties of both of which are hereby incorporated by reference.

### FIELD OF THE INVENTION

The present invention relates to methods for adapting a process model for operating one of multiple working machines, in particular self-propelled or towed harvesting machines, preferably for root crops.

### BACKGROUND OF THE INVENTION

A method is known from the prior art, for example, DE 10 2017 208 442 A1, for locally changing a process model on the basis of multiple user inputs on a working machine. The algorithm provided locally on the machine level is adapted on the basis of the user inputs, by which the simple process model of the working machine is changed. In this way, the working machine is in the best case optimized at the usage location toward a local optimum. With unpracticed users, this can however have the result that the working machine experiences a worse harvesting performance through the user inputs. In addition, the working machine is to be adapted again at a further usage location. Under unknown harvesting conditions or with unpracticed users, the algorithm therefore cannot function or at least cannot function optimally.

Furthermore, transmitting data which are obtained during a harvesting process about the processed material to a remote server and providing these data to a working machine processing the material later, for example, a combination of a tractor and a baling press, is known from WO 2018/206587. In that case also, only the items of location-related information about the harvested material are processed.

### BRIEF SUMMARY OF THE INVENTION

It is the object of the present invention to provide a method, using which a particularly good agricultural work result can be achieved upon use both at the same location and also at other locations for one or multiple agricultural working machines, in particular one or multiple harvesting machines. It is also the object of the present invention to provide subject matter suitable for this purpose.

A method according to the invention for adapting a process model for operating one of multiple working machines which comprise one first or multiple combined first agricultural working machines, in particular a self-propelled harvesting machine or a combination of a tractor with a harvesting machine towed thereby, preferably for root crops, and at least one, preferably multiple further working machines, is provided, wherein the adaptation takes place on an EDP device. This adaptation takes place on the basis of a first machine data set received via at least one interface from the at least one first working machine, which is in particular arranged remotely, during or after the operation thereof or on the basis of at least a part thereof. This machine data set comprises at least a part of a first working data set and at least a part of at least one following working data set.

Such a working data set, for influencing the agricultural work result in operation due to the first process model running on the first working machine, is used to generate at least one first process model output comprising at least one control command for at least one controllable or regulatable function unit of at least one of the first working machines. After the control command for the at least one controllable or regulatable functional unit of the working machine has been implemented by this functional unit, a following working data set results which, precisely like the first working data set, is capable of describing or defining a process state of the working machine.

The process model of the first working machine is used to generate, on the basis of an existing process state, at least one or generally multiple process model outputs comprising in each case at least one control command, which result in following process states. For example, it is recognized on the basis of the first process state and thus on the basis of the sensor data that there is a threat of a clog on a separating device of a first working machine designed as a potato harvester. A process model output, depending on the process model, can then have the result, for example, that the performance of the separating device is increased or the speed of a conveyor belt feeding toward the separating device is reduced. The interpretation of the machine sensor data that there is a threat of a clog can originate from the process model or from an upstream sensor data interpreter.

The first machine data set, which is obtained by the EDP device and is processed thereon, preferably comprises a first working data set which describes the first process state, at least one, preferably multiple working data sets which describe following process states, and the respective process model outputs, on the basis of which the following process state or states have resulted. If the process state processed by the process model is already known, the transmission of the process model output to the EDP device can possibly be omitted, if the same process model on the EDP device supplies an identical process model output with the known input variables.

The first and/or the further machine data set preferably in particular each contain at least one measure of the operator of the respective working machine (operator inputs), using which a process model output is overridden or manually initiated, in order to achieve a setting of a functional unit desired by the operator or a desired process state. Alternatively or additionally, at least one item of feedback information of the operator or a further person is contained in the respective machine data set, by which a satisfaction with the respective process state is described. This item of information is in turn associated at least with a number of sensor data which characterize the process state, and preferably stored in the respective working data sets.

According to the invention, on the EDP device, in consideration of items of information of the first machine data set, a further machine data set of one or multiple of the further working machines which has been formed analogously to the first machine data set, of the first process model and/or a further process model of one or multiple of the further working machines, a basic process model stored in the EDP device, the first process model and/or the further process model is now changed, in particular automatically. The changed process model is subsequently provided as the output process model for a preferably following operation completely or partially by the EDP device, in particular for transmission to the first working machine or one of the further working machines, and/or transmitted in the direction thereof. Accordingly, the process model changed on the level of the EDP device as the process model adapted for at least the one of the working machines then runs on precisely that machine in the following operation on the working machine. If the process model is only partially transmitted, for example, in the form of an adapted module of the process model or in the form of an adapted parameter data set, the process model is nonetheless designated in its entirety on the working machine as a new, changed, or adapted process model. This also applies if the process model is transmitted completely to one of the working machines.

Due to the adaptation of the process model on the basis of items of information of further harvesting machines, working machines can be adapted to different location conditions, without already having to have been at this location or an operator having to carry out a local optimization. The respective items of information collected on the working machines and in particular harvesting machines are rather used to, preferably automatically, optimize a process model for control and operation of the working machine and in particular the harvesting machine.

In particular, the machine data sets or the working data sets having possible items of feedback information contain evaluative specifications about the process quality and thus at least indirectly items of information about the settings performed by the process model running on the respective working machine. These are generated on the respective working machine directly or indirectly by the operator and/or by sensors or via the evaluation of their data. Alternatively or additionally, in a further embodiment according to the invention, evaluative items of information on the basis of the sensor data can first be generated in the EDP device.

On the EDP device, the adaptation of the process model is thus performed in particular in consideration of feedback and quality data on respective process states, which result due to process model outputs and possible measures of an operator. The process model to be changed is optimized on the EDP device for a variety of usage conditions by the items of information about the changing process states on the basis of respective process model outputs of various working machines. At the same time, the agricultural work result of not only one of the working machines, but rather in particular all working machines linked to the EDP device is improved. This applies all the more strongly when subjective assessments of the operators, their measures and/or the objective sensor-supported feedback data are taken into consideration in the adaptation of the process model on the EDP device.

In particular, the EDP device is arranged spatially separated from the working machine, wherein the communication between the working machine and the EDP device takes place via at least one interface. This at least one interface enables, for example, an Internet-based and wireless or wired communication between EDP device and working machine. For example, on the side of the working machine, a telemetry unit having a GSM module is provided, via which a connection to the Internet is enabled, wherein the EDP device is reachable by means of a web interface via the Internet.

The sum of the machine data sets is preferably stored in a database, which is associated with or included in the EDP device. It is obvious that the machine data sets advantageously each not only have a machine identifier, but rather in particular the working data sets contained in these data sets are provided with one or multiple timestamps or items of time information in order to be able to define the sequence of the process states and outputs or measures taken.

The process model which can run on the working machine, distributed onto one or multiple control units, can also run in a central control unit of the working machine. The control commands triggered or output by the process model represent a signal for activating an actuator in a simple case. However, a control command can also be a more complex command, for example, for an entire subunit of the working machine, which in turn again generates signals for actuators or commands for further subunits. Such control units influenced by the process model output are in particular, on the one hand, internal control units of the working machine, for example, for the travel speed and power supply of the machine as a whole, and, on the other hand, individual subunits such as the root crop receptacle, the control of the screening belts, the control of the recording and the setting options for the individual separating devices with respect to their speed, setting angle, and further other parameters, which influence the performance of the separating devices and the separating result. For example, the process model can set the setting of the speed of the screening belt conveyance, the beaters and other devices of the screening belt, the height of fall stages of separating devices, etc. In general, every controllable or regulatable assembly of the working machine can be activated by the process model. The overall regulating mechanism, which the process model represents on the EDP device, is accordingly complex. This typically involves a large number of interdependent rules of a regulating mechanism or algorithms which result in the output of the control commands. In addition, the process model can possibly also represent outputs to external control units, which, for example, in the form of a tractor pull a towed harvesting machine and regulate its speed. Depending on the embodiment of the invention, an output can also be made at an HMI interface, so that certain actions can be triggered by the operator of the working machine.

For the sake of simplicity, in general only a first working machine, in particular a self-propelled harvesting machine for root crops comprising potatoes or beets, is presumed hereinafter. However, this can just as well also relate to a combination of first working machines.

The agricultural work result is preferably the amount of harvested crop located in a bunker of the harvesting machine or a transfer vehicle, which has a specific cleanliness, i.e., freedom from admixtures and soil, and a specific freedom from damage, and wherein this harvested crop was harvested within a specific time.

It is obvious that knowledge about the origin of the data set is advantageous for the transmission of the machine data set on the part of the EDP device. Such a machine data set therefore reasonably also has a specific identifier, which can be associated with the working machine. Alternatively or additionally, a corresponding item of information can also be transmitted from the working machine to the EDP device or the information can also be queried by the EDP device from the working machine in a bidirectional method during the transmission of the machine data set.

Depending on the design of the data set, the machine data set can be transmitted piece by piece or also in its entirety or also as a continuous stream of data. It is also conceivable that firstly one or multiple parts of first working data sets and then associated following working data sets are received by the EDP device. Accordingly, the machine data set, which overall describes successive process states during a harvesting procedure on the EDP device, is not transmitted chronologically with respect to time.

The transmission of the data preferably takes place wirelessly via known communication devices. Alternatively, the EDP device can also have an interface for wire transmission or for transmission via memory media.

The EDP device is designed in general to store corresponding data, process this data, and communicate with the working machines. It can be a cloud-based, server-type EDP device, which runs distributed on one or multiple computer units or servers. Alternatively or additionally, it can also be an EDP device located locally, for example, at a contractor or a harvesting machine producer, which has units typical for this purpose such as volatile and nonvolatile memories and typical processor units (for example, CPUs and GPUs). Due to the large amounts of data, it is preferably an EDP device which communicates with a database or is provided with a database, in which the data sets of the working machines are stored.

In specific cases, the EDP device can also be an EDP device provided on a working machine, the process model of which is changed by machine data sets of the further working machines.

The adaptation of the basic process model, the first process model, or the further process model takes place on the basis of items of information of the machine data sets or the preceding process models. The data stored in these process models or machine data sets can be used directly or can be processed on the EDP device, which is the typical case, so that these are items of information derived from the preceding data sets. The items of information which result in the change of at least one of the process models can also be items of information combined from various data sets and process models.

The harvesting performance of a modern harvesting machine is determined by a large number of variables, which are partially dependent on one another and are nonetheless external, wherein a process model for operating the harvesting machine is, on the one hand, to depict the relationships as precisely as possible, but at the same time has to run as robustly as possible in greatly varying boundary conditions and under greatly varying process goals. A model which runs precisely for a broad usage range is provided by the method according to the invention due to the large number of items of information from multiple working machines which are processed on the EDP device.

Since a process model can also be constructed modularly using individual modules provided for the control of specific control units, to change the process model on the relevant working machine, this process model can also only be transmitted partially in its changed parts, so that in sum a process model which is nonetheless only changed partially results, however. This serves the efficiency and speed of the data transmission.

It is apparent that the EDP device is designed to receive the data transmitted from the working machines encrypted specifically by machine or to encrypt the corresponding data to be transmitted to the respective working machines accordingly and to provide the data so they are only readable for this working machine. Such an encryption can be carried out, for example, on the basis of the machine ID.

The first working data set, which is processed on the EDP device, is formed in particular by first operating parameter data, first machine sensor data, first functional unit data, and/or first working data derived from these data, in particular wherein the first working data set furthermore contains associated feedback, assessment, and/or operating input data.

Operating parameter data are in particular data which are specified at the beginning of an assignment or during the assignment by the operator or are specified in standard form. For this purpose, for example, a harvesting strategy, a harvested crop size, a harvested crop type, the soil consistency, the operating goal (for example, harvested carefully or quickly), or also further target value specifications such as a maximum or a minimum speed are specifiable by the operator as operating parameters. Machine sensor data, also referred to hereinafter only as sensor data, are data which are obtained by sensors of the working machine and possibly the evaluation thereof. These can be pressures of individual functional units or their actuators, fill levels at specific points of the device, speed of individual components, spacing of individual components movable in relation to one another, 2D or 3D recordings, acoustic recordings, and/or items of position information. These data are also optionally processed in a signal processing unit and interpreted so they are usable for the process model. The process model can optionally perform this interpretation itself or the data are entered directly in the process model.

It is apparent that, for example, the soil consistency can also be variably detected and used in the evaluation in the presence of corresponding sensors and these items of information are then used either as variable operating parameter data or as sensor data of the machine. In addition, for example, items of information can be incorporated as functional unit data in the machine data set from the individual functional units of the machine, for example, the individual separating devices or the other functional units; this applies in particular to situations in which, for example, specifications are made on the part of the control output of the process model, which cannot be implemented by the functional units, whether due to inadequate performance or other failures such as clogging of the material flow, which results in blockages.

In particular items of process feedback information on specific critical areas in the harvesting procedure, for example, desired fill levels at specific separating devices and the assessment thereof, the identification of damage in the harvested crop, and the assessment thereof can be part of the machine sensor data. Alternatively or additionally, such assessments or items of feedback information can also enter into the operating parameter data due to in particular an input of the operating person during the harvesting procedure. These data can be used directly or as already statistically processed and/or interpreted working data. While the first working data set is formed by corresponding first system states, which are formed by first operating parameter data, first machine sensor data, first functional unit data, and/or first working data derived from these data, the following working data set is preferably at least partially formed by following machine sensor data, following functional unit data, following operating parameter data, and/or following working data derived from these data, in particular wherein the following working data set furthermore contains associated feedback, assessment, and/or operating input data. The first working data set therefore describes a first process state of the working machine, while a following process state is described by the following working data set, which results due to a control or regulation generated by the process model and possibly due to any operator inputs.

Operating input data are in the present case those data which result due to an input, and are at least partially overridden or replaced using a process model output, preferably to deliberately set a controllable functional unit.

To avoid excessive unrest in the regulating processes and the control of the working machine, the data described in each of the data sets can also be averaged data, which result from an observation over a certain period of time, for example, in a following working data set from averaging of machine sensor data over a specified or specifiable time span.

For the purpose of continuous further improvement of the process model, it is advantageous that a new output process model is subsequently used as the new basic process model. The setting of the output process model as the basic process model can be performed by an assessment criterion about the relevance or the degree of the change. This is advantageous in particular if the process model is usable not only for one type of working machine, but rather for multiple different types of working machine, for example, different types of potato and/or beet harvesters.

According to one refinement of the method according to the invention, the machine data sets of multiple working machines are each allocated into individual groups, in particular assemblies, for machine-spanning comparability. The multiple working machines are working machines operating independently of one another, i.e., for example, a first and a further working machine which are in particular underway at different locations. On the one hand, this serves for the efficiency of the adaptation and optimization of the process model running on the EDP device, wherein the scope of processing is reduced. On the other hand, various machine types, which have functional units or assemblies operating or acting identically in principle, however, are comparable. For example, towed and self-propelled potato harvesters in principle have identically acting separating devices for separating the root crops from undesired admixtures. A group of data derived from the respective data sets can be, for example, such an identically occurring separating device or a combination of a feeder unit with the separating device. Separating device-specific groups are, for example, star-shaped screening disks or screening belts, separating devices based on airflow or provided with individual striking elements, separating devices having finger belts running at an angle via a belt or screen roller arrangements. Other functional units are, for example, a receptacle for potatoes, beets, or vegetables, possibly in combination with head or mallet units or head and/or mallet units alone. Drive, transfer, and bunker units can also form functional units which are activated via the process model.

The machine data sets for adaptation of the basic process model are preferably initially filtered in a filter module on the EDP device. For this purpose, the filtering of the data sets, which in particular runs automatically, can preferably take place specifically by assembly according to the above-described assemblies. The filter properties are preferably directly related to the goal of the specific process model development, for example, for a specific working machine type or in dependence on operating parameters such as usage goal, harvesting strategy, or usage location. In addition, various adaptations can be prepared by means of the filter module on the EDP device. For example, in the filter module, certain points in time or time ranges are selected or measures taken, sensor data, or process states of the respective machine data set are averaged over specific time frames.

Furthermore, according to a further design of the method according to the invention, a plausibility check of a respective machine data set or the working data set contained therein can be performed in an assessor module on the EDP device. For this purpose, corresponding properties and requirements for the data sets are stored in the assessor module. These properties are parameterizable and/or adaptable. For this purpose, machine data sets or working data sets which are inconsistent, for example, due to faulty transmission or faulty process states, are excluded from the further observation and adaptation of the respective process model, so that the process model is not negatively influenced and corrupted.

According to one refinement of the method according to the invention, the process model to be changed is changed in at least one assembly-specific module. A change of the process model is thus performed deliberately for individual assemblies, without always having to adapt or change the complete process model in each case, which is advantageous in particular if new assemblies or new control devices are used in a machine-spanning manner. After such an assembly-specific adaptation, the adapted process model module is assembled or compiled with further process model modules to form a changed process model. Alternatively or additionally, the changed process model module can be provided separately for transmission to a working machine in order to replace the corresponding component therein.

Preferably, items of adaptation information are recorded by an observer via an observer interface for adapting the basic process model. The observer interface is associated with the EDP device and is designed, for example, for developers of the process model as an HMI (human-machine interface). In particular, items of feedback information can be supplemented and associated with the respective working data sets via such an interface. Adaptations can also be performed to the adaptation routines and/or the filter module via such an interface. For example, timescales to be observed in the filter module are specified via such an interface.

Alternatively or additionally, an observer associated with the EDP device can also be designed as a program module or algorithm which in particular uses the items of information of one or more sensors. The specifications or inputs of this observer via an internal interface in particular have the result that various adaptation strategies are calculated and assessed, of which a reasonable one is subsequently selected.

One refinement of the method according to the invention is distinguished in that the process model to be changed is changed by means of at least one method of artificial intelligence, in particular by reinforcement learning. The latter in particular suggests itself if items of feedback and/or assessment information are provided on the EDP device. These can be contained in the respective machine data set and/or generated on the EDP device.

According to the invention, items of feedback information of an operator or observer of the first or one of the further working machines are advantageously used for the adaptation, preferably wherein weighted state transitions are adapted from the items of feedback information to generate a changed process model output. A state transition which is stored in the process model and effectuated thereby is described by one or multiple process model outputs, due to which a transition takes place from, for example, a first scenario characterized by first sensor data to a following scenario characterized by following sensor data. For example, the first working data set contains a first scenario while the following working data set contains the following scenario resulting due to the process model output, i.e., the measures initiated by the process model in the form of control commands to the controllable and/or regulatable functional units. The items of feedback information are provided in particular in the machine data sets.

Preferably, in an adaptation by means of reinforcement learning, a process model is used in which a weighted regulating mechanism for generating a process model output is already contained. In an adaptation module of the EDP device, the process model is then further developed completely or in individual process model modules on the basis of the first and following working data sets and the associated process model outputs in consideration of the associated feedback, in particular of multiple working machines. Due to the observation of the development, which is reflected in the first and following working data sets (and in particular the sensor data), in consideration of the feedback and/or the assessments on the process states depicted by the sensor data, the weights or probabilities are adapted, by which the transitions from one state into another are obtained on the basis of process model outputs or measures. Subsequently, in the adaptation module, after the observation of all relevant data sets, in particular of multiple working machines, the finally ascertained weighted state transitions are used to thus adapt the measures in the corresponding process model. In the case of multiple quality levels of the feedback, beginning at a distinction between “good” and “poor”, but in particular with an assessment on a scale having at least two and fewer than 10 levels, state transitions or measures of a specific working machine, which provides particularly good harvesting performances, can be weighted higher than those from the working machines which provide less good performances.

Advantageously, the output process model is validated before the transmission to the first working machine in a validation module and/or on a further real or virtual working machine. The process model or its individual modules can be checked for this purpose against defined test cases. Thus, for example, on the basis of predetermined test scenarios and thus predetermined sensor data, operating parameter data, and further items of information, the process model output can be checked with respect to permissible values. If the working machine is virtualized, i.e., a computer model of the working machine is generated, which can be subjected to virtually changing harvesting conditions and which then models the crop flows to be processed and therefore process states resulting therefrom, this can also be made the subject matter of the validation module.

The machine sensor data and/or the operating parameter data preferably comprise environmental data, i.e., location data, soil data, and weather data. External operating parameter data, for example weather data, can also additionally be incorporated automatically into the data set separately via interfaces by the respective working machine or are integrated in the database on the EDP device according to the invention by means of a corresponding interface.

If a possible validation has been successfully run through, subsequently an adapted and optimized process model or process model module is provided. If only individual assemblies or modules of the process model have been optimized, these can be assembled separately as already described or on the level of the EDP device to form an updated process model, in order to then be transmitted for transmission to the working machine(s).

Preferably, the output process model is made available at least partially to the operator of a working machine or also third persons on a mobile device for app-supported generation of action instructions (on the basis of specific process states), wherein in particular feedback input by the operator or the third party on the mobile device or a further EDP device is used for adaptation of the process model to be adapted (i.e., the process model of the first one of the further working machines, or the basic process model). Via such an interface, monitoring functions, which are exercised by the operator or a third party, can be used directly to refine the process model.

Via an auxiliary interface of the EDP device, a number of items of information for supplementing the first or one of the further machine data sets can be made available to the method according to the invention running on the EDP device. These can be items of weather information, as already described; alternatively or additionally, these can also be items of classification information, items of information about admixtures or about storage damage, which were only acquired after a harvesting procedure. It is apparent that these items of information can also in turn be associated with the respective data sets and working machines.

If a plurality of correspondingly equipped EDP devices for the purpose of adapting the process models of a plurality of working machines is provided, the machine data sets depicted in a database of the EDP device can be supplemented with machine data sets of other working machines depicted in a further EDP device. The other working machines are preferably working machines different from the first and further working machines. Due to the pooling of the data sets, the findings of other working machines can then be added to those of one's own working machines. For example, in this case this can involve the linking of data sets which were obtained in North America or Asia with data sets in Europe.

The object stated at the outset is also achieved by an EDP device having at least one computer program product, which are distinguished in that they are designed for carrying out the method described above or hereinafter. Such an EDP device has the electronic means typically provided for data processing.

The object stated at the outset is also achieved by an item as claimed in claim 16. By using a process model changed according to the method described above or hereinafter, such a harvesting machine achieves better harvesting performance even in harvesting conditions in which this harvesting machine has not yet been used. It goes without saying that the harvesting machine is equipped with the technical means necessary for carrying out the method described in the form of sensors, data storage means, internal and external communication interfaces to the operator and to the EDP device and equipment in general and the operating system of the harvesting machine is appropriately designed to upload machine data sets and to receive a changed process model or to receive parts thereof and to assemble them to create a changed process model on the harvesting machine itself.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows the control sequence locally on a working machine.

FIG. 2 shows a schematic diagram of a subject matter according to the invention.

FIG. 3 shows an explanation of a process model.

FIG. 4 shows an exemplary embodiment of an adaptation module.

FIGS. 5 and 6 show analysis data for adapting a regulating mechanism of a process model.

### DETAILED DESCRIPTION OF THE INVENTION

Individual technical features of the exemplary embodiments described hereinafter can also be combined in combination with above-described exemplary embodiments and the features of the independent claims and possible further claims to form subjects according to the invention. If reasonable, functionally identically acting elements are provided with identical reference numerals.

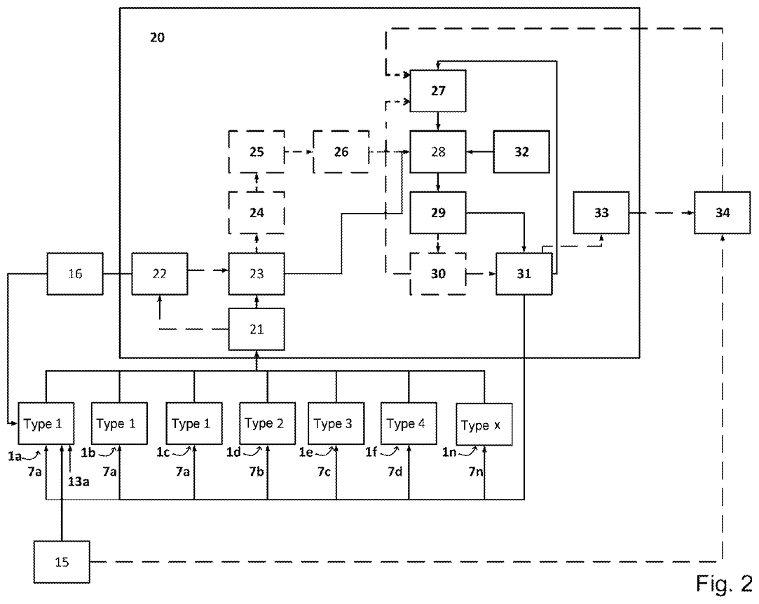

A process model to be adapted is embedded as follows in a respective working machine, characterized by a box 1. Correspondingly, there are then individual control sequences for each working machine 1, which is equipped with a corresponding system structure, which are identified for the n working machines by 1a, 1b, 1c . . . 1n (see FIG. 2). These control sequences can be provided on working machines of the same type and the same configuration; however, it is provided that different machine types and configurations can also be compared to partially identical assemblies and thus an experience exchange is advantageous on the part of the EDP device.

In block 2, operating parameter data are provided due to operating parameters, which are defined via a human-machine interface or also detected by sensors. These can be harvesting strategies, harvested crop sizes, types, or various soil consistencies for the field to be processed and operating goals. A queried process feedback of an operator which is triggered via specific events can also be stored in the block 2. Process feedback data or feedback data or items of feedback information are used synonymously for the purpose of this application. For example, harvesting strategies oriented to quality or throughput, optimized for loss or optimized for admixtures come into consideration as harvesting strategies, on the specification of which specific settings of the functional units and the control units thereof are performed. The process feedback data can be performed, for example, in a time-controlled manner and feedback can take place on higher-order goals, for example, the satisfaction of the operator with the harvesting result or also feedback on part-specific goals (for example, how satisfied they are with the separation in the separating device 1 (TG1), in the separating device (TG2) of the screening performance on specific screening belts, etc.). These assessments are preferably conceivable in at least two levels (good/poor). The inputs are preferably input by the operator directly on the machine. The input of process feedback can, on the one hand, take place triggered by the machine controller, for example, after defined harvesting time frames or larger setting changes by the process model in block 7 or they can take place non-triggered, i.e., the driver gives feedback when it suits him. It is relevant that this feedback input is linked in each case to specific process states, i.e., to the sum of items of information describing the respective state of the machine. This can be, for example, via an item of time information or via a direct linkage of the items of feedback information to the sensor data and operating parameters provided at the point in time of the feedback. If a complete set of operating parameters is not provided at the beginning of an operating procedure of the working machine, this can be queried or specified internally or externally.

While block 2 involves items of specified or in particular also external information, in block 4, sensor data of the sensors provided on the machine are collected. These can be all types of sensors which are provided on a working machine. For example, they are mechanical, optical, or acoustic sensors. These can also be provided at all conceivable positions at which items of process information can be obtained. For example, these are fill level sensors in the area of the screening belts or separating devices or pressure sensors for determining the drive pressure of hydraulic drives. In addition, these can be sensors which directly ascertain the process feedback. The advantage of the sensorial acquisition over the acquisition of the process feedback via inputs of the operator in block 2 is that, on the one hand, a more objective assessment base is provided over the subjective, operator-specific feedback, in particular more high-frequency information, and, on the other hand, process feedback can be continuously collected by means of the sensors. The sensor-based feedback collection additionally has the advantage that the operator is not unnecessarily distracted or fatigued. The sensor data can be updated either as items of raw information and raw data directly in the process model in block 7. They can alternatively or additionally also be processed and interpreted in a signal processing module or interpreter module according to block 5, also called a sensor data interpreter, and converted, for example, into other state variables describing the process. This applies in particular to items of 2D or 3D information which generally have to be interpreted in separate evaluation devices.

For example, an item of feedback information can first be generated about the presence of a clog or about an imminent clog at a separating device in block 5. A further example of the sensor data provided in block 4 are items of location information and/or speed information, which are obtained via internal position sensors. Data from blocks 2, 4, and 5 are therefore considered to be working data. Items of information derived from these data, in particular items of process state information describing a process state, can also be considered to be working data. These can result due to a categorization or a statistical evaluation of a large number of simultaneous or successive sensor data.

The items of information compiled in a working data set are temporarily stored in a data set module 3. In the data set module 3, in which preferably all working data sets are stored before they are transmitted to the EDP device, process model outputs and/or measures of an operator which have the result that process model outputs are overridden are each stored associated with the working data sets or separately. It is advantageously configurable which data can be extracted from the sensor data and operating parameters, in order to store them in the data set module 3. Those process data, using which statements can be made about the process state at a defined point in time, in particular the period of time immediately before and after process feedback, are relevant. In particular, these data sets can be allocated and/or compressed with respect to their memory size so that they can be transmitted by means of a telemetry unit 6 to an EDP device, characterized by a box 20 in FIG. 2. Accordingly, the data sets are transmitted according to arrow 14 upon definable events, for example, reaching a minimum size, connection to a communication medium, for example, upon provision of a mobile wireless connection or the presence of a USB stick, via an interface from the system according to arrow 14 to the EDP device 20. In addition, items of information can also be introduced externally into the data set by the telemetry unit 6, for example, items of weather and environmental information according to the arrows 12 and 13. For example, these can be items of environmental information such as soil type and soil consistency, which are transmitted, for example, from external maps.

It is also advantageous if, in the case of a telemetry unit 6, in particular in the form of a wireless interface, which functions via mobile wireless, WLAN, or Bluetooth, preferably in the close range of the working machine, a process observer 13a (FIG. 2) connects from outside the working machine and, for example, views camera images or monitors other sensor data and gives feedback thereto. Such feedback can also again preferably be stored according to data arrow 12 in the data set module 3 and linked to the respective working data sets which describe the associated process scenario.

In particular, time stamps or also defined events on the basis of, for example, an event counter are used for the linkage of the individual data set elements.

A process model is transmitted to the process module 7 via the communication interface or telemetry unit 6 according to the data input arrow 13. This process module 7 can be located centrally on a control device and distributed onto multiple control devices. The process model thus consists of one or multiple software components, which are incorporated in the machine controller or are executed for the machine controller. In particular, the input signals on the part of block 2 (operating parameters) and the sensor data (blocks 4 and 5) are converted into control commands on the basis of the process module 7. These measures for controlling the working machine can be transmitted by the process module 7, on the one hand, to external control units in the block 9, for example, a tractor of a towed harvesting machine, and to internal control and functional units (block 8). The data of the functional units are possibly also added as functional unit data in a respective working data set in the data set module 3, which is not shown in the present case in the graphic.

In block 8, the individual functional units or assemblies of the working machine and its control units are realized. In particular, these are actuator activations that influence the process result of the working machine, in the example of a potato harvesting machine thus all cleaning and separating devices from the receiving of the crop flow to the bunker or a transfer device. Such functional units are often connected via a CAN bus system or hardwired directly by the control device. A tractor unit is connected, for example, via the TIM protocol (module 9).

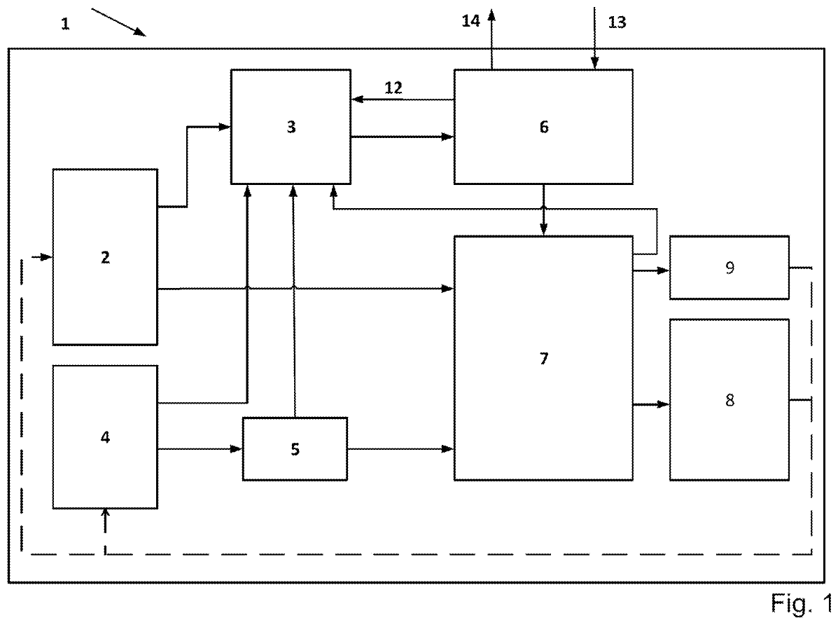

According to the invention, a method for adapting a process model on the level of the EDP device now runs in block 20 as described hereinafter. Firstly, a collection of all machine data sets is performed in a data collection module 21. These are machines of various types in this case (cf. machine type 1, machine type 2, machine type 3, machine type 4, machine type X). The control procedures 1a to 1n run on these machines corresponding to FIG. 1. Different process modules 7 are accordingly implemented on the respective process modules 7 of these working machines, which can be processed at least in parts jointly on the EDP device due to their fundamentally similar structure and due to identical assemblies, however. For example, the respective working machines are various embodiments of potato harvesting machines, beet harvesting machines, each in towed or self-propelled variant, and/or having receptacles for different numbers of potato ridges or beet rows, respectively.

As an example, a feedback by an operator 15 is shown on the far left only for the machine identified by an operating sequence 1a. The other working machines having the respective process model variants 7a, 7b, 7c, 7d, and 7e could also in principle be provided with items of information by external operators if corresponding interfaces are provided.

Also by way of example, only the supply of the left working machine in the figure with further items of environmental information, for example items of weather information, from an information source 16 is shown.

After receiving the data in the data collection module 21, which in particular represents an interface for the connection of the preferably local working machines remote from the EDP device, it can be reconciled using the data set supplementation module 22, to which an auxiliary interface is assigned, whether still further external items of information have to be added to the machine data sets or the respective working data sets. These can be items of weather information, items of classification information, or other external items of information.

This supplementation is not necessarily to be carried out. In general, the dashed boxes and arrows in the diagram of FIG. 2 represent optional variants, each according to further exemplary embodiments of the invention. In a data set memory 23, in particular designed as a database, the machine data sets of all working machines are then collected. In an optional extraction module 24, the items of data set information of individual machines can be extracted in individual groups, allocated according to assemblies, for example, for the purpose of machine-spanning comparability. That is to say, after the processing steps in the extraction module 24, the data are allocated according to selectable or definable properties, for example assembly or separating focus. Subsequently, the data are prefiltered in the filter module 25 in a next processing step. These filter properties are in particular directly related to the goal of the specific process model development, for example, the process model development for a specific machine type and/or depending on usage goal, harvesting strategy, or usage location or usage year. It is subsequently checked in an assessment module 26 whether the items of data set information are complete and plausible. For this purpose, corresponding properties and requirements for the data sets are stored in the assessment module. These properties are parameterizable and adaptable. The goal is to only let through those data sets for further adaptation of the process model in the adaptation module 28 which are consistent and reasonable.

Instead of the access to the data of the optional modules 24, 25, and 26, alternatively or additionally, the data of the memory module 23 can be directly accessed in an adaptation module 28. In the adaptation module 28 a process model stored in an output base 27 as the basic process model is adapted by methods of artificial intelligence, in particular by reinforcement learning. The new and adapted process model thus generated can be validated in the following step against defined test cases (validation module 29). Subsequently, an adapted process model or at least an adapted process model assembly is provided. This is then formed in step 31, possibly together with further process model modules, into the machine-typical process model, the output process model. Via a feedback loop, the assembly-specific process model generated in the module 30 can in turn be written back into the output base in the module 27. Alternatively or additionally, other process models can also be adapted in the adaptation module 28, for example, the process model of the first or the following working machine. Furthermore, items of adaptation information, for example, developer specifications, can be updated and taken into consideration via an observer interface in the form of an interface module 32.

The output process model can optionally be generated in block 33 for the app-based generation of action instructions and thus as a mobile device variant, which can be transmitted to a mobile device 34. By means of this mobile device 34, items of feedback information of the operator 15 can in turn also be made in the direction of the adaptation module 28 or also toward the data set memory 23. The output process model is then completely or partially made available specifically by machine type in the variants 7a to 7n to the respective working machines for an adaptation or change of the process model respectively provided on the working machine and for an in particular following operation.

It is also conceivable that the EDP device in one embodiment variant is located on a local working machine 1 and the method according to the invention is thus executed there. Accordingly, however, one or multiple communication interfaces are then to be provided, via which the relevant data sets can then be transmitted via the further or other working machines.

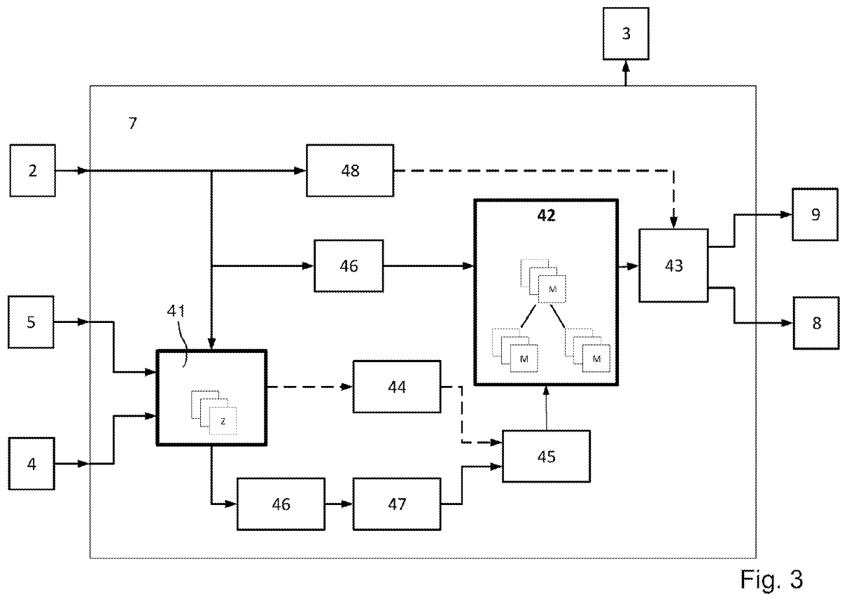

A process model adapted in the scope of the invention to the EDP device is explained in still more detail with its individual components in FIG. 3 on the basis of a working machine. The essential components of a process model in this case are the two process knowledge components 41, in which a library having the process states is provided, and the regulating mechanism module 42 having the regulating mechanism with respect to the process states, the process goals, and the measures M, which are transmitted in the form of control commands in block 43 to the external and internal functional units of blocks 8 and 9. The essential task in this exemplary embodiment of the process model is first to ascertain a known process state, subsequently to select a corresponding measure on the basis of the process state and the process goal from the regulating mechanism, which is then converted into the control commands in block 43.

Upon the initial operation of the process model, for example, after a working machine start, a process state is not yet defined. Initially at least one process state is ascertained in the block 41 solely from the operating parameters originating from the operating parameter module or block 2. An initial process state is insofar provided in block 44 for the beginning of the operation of a working machine. The operating state or process state defined in block 44 is set as the active process state in block 45. Proceeding from this process state 45 and by means of the process goal in block 46, the most suitable measure is ascertained in the regulating mechanism module 42 for the process state provided in block 45, in order to achieve the transition to the process goal.

In normal operation, the process state is ascertained continuously from the sensor values and the operating parameters (blocks 2, 3, and 4) on the basis of the defined process states. This process state is initially stored in block 45 as a temporary process state. Such a temporary process state can typically be ascertained at quite high frequency, since sensor values change frequently. In order that the regulating system does not become unstable due to excessively frequent state changes, however, it is reasonable to make this temporary process state more stable by filtering of the state change. This takes place in module 47. Time averaging of the data preferably takes place over time periods between 6 seconds and 600 seconds. The control commands resulting due to the regulating mechanism then implemented in block 43 can be overridden manually according to a specification in block 48 by an operator 15.

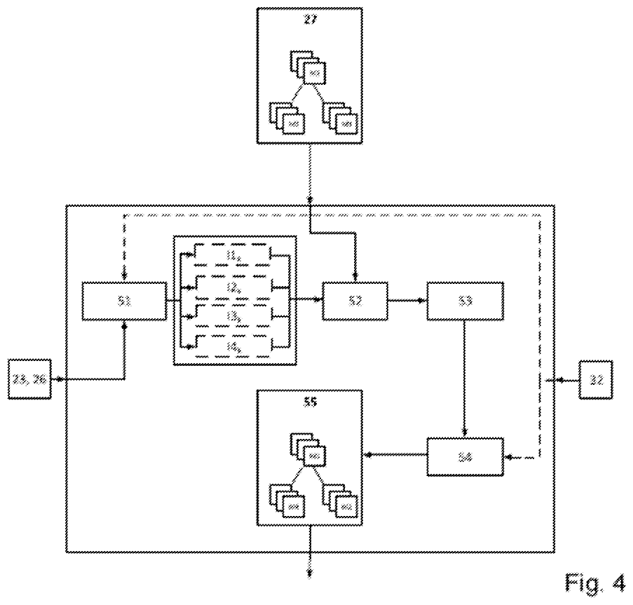

An exemplary embodiment of the adaptation of a regulating mechanism or the process model in the adaptation module 28 on the level of the EDP device is shown in FIG. 4. Initially, the adaptation module 28 receives one or multiple machine data sets or parts thereof. These data can accordingly be provided unfiltered from the database from the module 23 or also filtered according to assemblies or plausible/consistent data according to block 26. All included scenarios, for which feedback is provided, are now extracted from these data sets. A scenario is defined in this case by the presence of at least four items of information. A scenario is a combination of a) a process state according to the first working data set, with b) a process state according to the following data set, with c) an associated process model output or measure which has resulted in the transition from the first process state to a following process state, and with d) associated feedback on the part of either the sensors and/or an operating unit.

After the extraction of the scenarios in the extraction module 51, a total of n scenarios are then provided, characterized by the above-described four items of information I1ₓ, I2ₓ, I3ₓ, I4ₓ, with x=1 to n. Each of these extracted scenarios is then passed on to a reinforcement learning agent in module 52. This agent uses the process model to be changed, in which already weighted state transitions due to corresponding measures are contained, and learns further on the basis of these scenarios. While it goes through the scenarios, it adapts the weights or probabilities using which the transitions from one state into another are defined on the basis of measures. After the agent has played through all scenarios for all data sets which are made available to the adapter in the adaptation module 28, the finally ascertained weights are used in the state transitions to thus adapt the measure sequence in the regulating mechanism, for example, by reordering if a measure has changed relevantly in relation to the output model. The ascertainment of weighted state transitions takes place in block 53 and the adaptation of the regulating mechanism then takes place in block 54. By means of a developer interface, it is possible to act from block 32 both on the process of the change of the regulating mechanism and on the extraction of the scenarios. The finally adapted regulating mechanism is then stored in block 55 and can be transferred therefrom for validation to the validation module 29. While the regulating mechanism described in FIG. 4 is generally a regulating mechanism based on a graph or tree structure, it is obvious that such a regulating mechanism can also be provided as a precisely mathematically defined regulating mechanism. It can also be a neural network in which weights are adapted based on items of feedback information. In a more precisely defined, rule-based process model, one or multiple regulators are then precisely regulated in dependence on the process variables on the basis of the sensor data and the operating parameter data. The regulating parameters are then changed as described above, for example, in the adaptation module 28 on the basis of the items of feedback information.

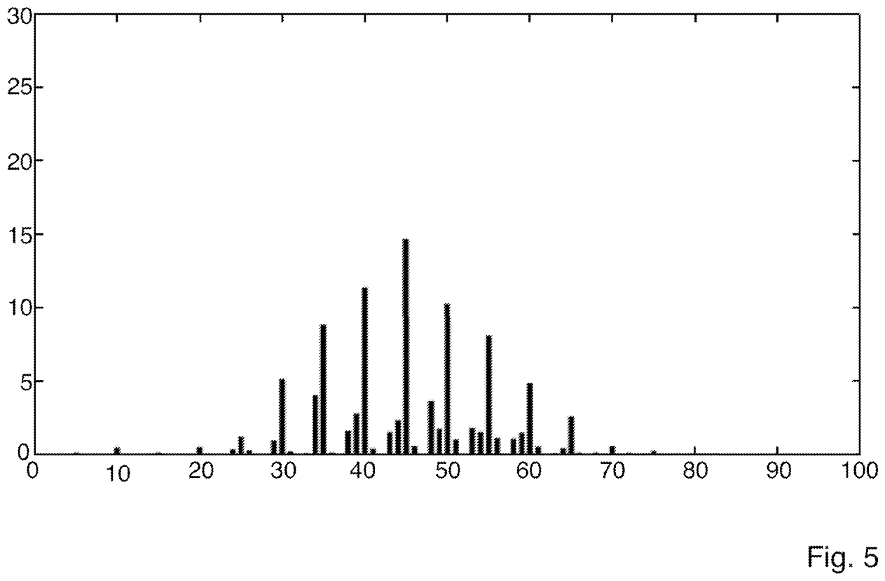

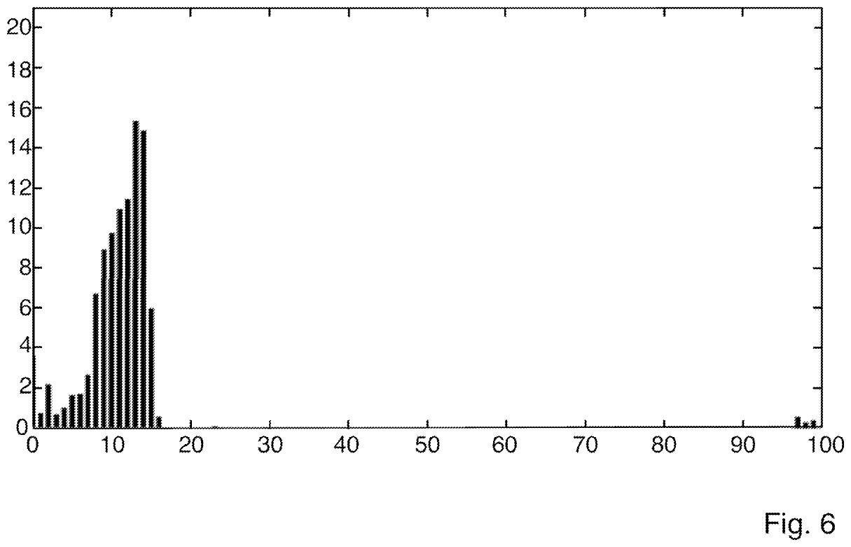

The illustrations of FIGS. 5 and 6 show on the X axis the possible target value setting options, for example, of a hedgehog web speed (FIG. 5) and a height of a stripping shaft in the same separating device (FIG. 6). The relative usage duration of the target value during the harvesting over a defined period of time is plotted on the Y axis, in the present example over a year. The comparison of the two illustrations makes it clear that the setting ranges can be reasonably limited in working operation, in the example of the stripping shaft (FIG. 6) to a value range of 0% to 20% and in the example of FIG. 5 to a value range of 10% to 70%. This is a result of an observation in the adaptation module 28, in which during the adaptation, the setting ranges used often are weighted more strongly than the unused setting ranges, whereupon a restriction of the setting range results.

1. A method for adapting a process model for operating one of multiple working machines which comprise one first agricultural working machine or multiple combined first agricultural working machine, and at least one further working machine, wherein the adaptation takes place on an EDP device, the method comprising:
generating, to influence the agricultural work result, at least one first process model output comprising at least one control command for at least one controllable or regulatable functional unit of at least one of the first working machines, in operation, by the first process model running on the first working machine based on at least one first working data set, by which at least one following working data set results,
receiving, by the EDP device via at least one interface from the at least one first working machine, which is in particular arranged remotely, during or after the operation thereof, at least a part of a first machine data set comprising:
at least a part of the first working data set and
at least a part of at least the or one of the following working data sets, and
changing, on the EDP device, a basic process model stored in the EDP device, the first process model or the further process model in consideration of:
items of information of the first machine data set,
a further machine data set of one or multiple of the further working machines, of the first process model and/or a further process model of one or multiple of the further working machines,
subsequently providing at least a part of the changed process model is subsequently as the output process model for an operation by the EDP device.

2. The method as claimed in claim 1, wherein the first working data set is formed by first operating parameter data, first machine sensor data, first functional unit data, and/or first working data derived from these data.

3. The method as claimed in claim 1 wherein the following working data set is at least partially formed by following machine sensor data, following functional unit data, following operating parameter data, and/or following working data derived from these data.

4. The method as claimed in claim 1, wherein the output process model is used as the new basic process model.

5. The method as claimed in claim 1, wherein the machine data sets of multiple working machines are each allocated into individual groups for machine-spanning comparability.

6. The method as claimed in claim 1, wherein the machine data sets for adapting the process model are filtered in a filter module.

7. The method as claimed in claim 1, wherein the process model to be adapted is changed in at least one assembly-specific module and this is combined or compiled with further process model modules to form a changed process model.

8. The method as claimed in claim 1, wherein items of adaptation information are recorded via an observer interface of the EDP device for adapting the process model.

9. The method as claimed in claim 1, wherein the process model to be adapted is changed by means of at least one method of artificial intelligence.

10. The method as claimed in claim 2, wherein items of feedback information of an operator or of an observer of the first working machine or one of the further working machines are used for the adaptation.

11. The method as claimed in claim 1, wherein the output process model is validated before the transmission to the first working machine or one of the further working machines in a validation module and/or on a further real or virtual working machine.

12. The method as claimed in claim 1, wherein the output process model is made available at least partially to an or the operator of one of the working machines on a mobile device for app-based generation of action instructions.

13. The method as claimed in claim 1, wherein the EDP device receives items of information to supplement the first or one of the further machine data sets via an auxiliary interface.

14. The method as claimed in claim 1, wherein the machine data sets depicted in a database of the EDP device are supplemented with machine data sets of other working machines depicted in a further database of a further EDP device.

15. An EDP device having at least one computer program product, wherein the computer program product carries out the method as claimed in claim 1.

16. A harvesting machine characterized by a process model; that is changed according to the method as claimed in claim 1.

17. The method as claimed in claim 1, wherein the first agricultural working machine is a self-propelled harvesting machine, or the multiple combined first agricultural working machines are a combination of a tractor with a harvesting machine towed thereby.

18. The method as claimed in claim 1, wherein the EDP device is arranged remotely from the at least one first working machine.

19. The method as claimed in claim 1, wherein the step of subsequently providing at least a part of the changed process model as the output process model for an operation by the EDP device is for transmission to the first working machine and/or one of the further working machines, and/or transmitted in the direction thereof.

20. The method as claimed in claim 2, wherein the first working data set furthermore contains associated feedback, assessment, and/or operating input data.

21. The method as claimed in claim 3, wherein the following working data set furthermore contains associated feedback, assessment, and/or operating input data.

22. The method as claimed in claim 6, wherein the machine data sets for adapting the process model are filtered by assembly in a filter module.
